(19) United States
(12) Patent Application Publication
(10) Pub. No.: US 2013/0073452 A1
(43) Pub. Date: Mar. 21, 2013

(54) SYSTEM AND METHOD FOR PROVIDING ACCESS TO REMOTELY STORED DIGITAL MEDIA USING AN RSS FEED

(71) Applicant: Open Television Network, Inc., Burbank, CA (US)

(72) Inventors: Philip Hodgetts, Burbank, CA (US); Gregory Clarke, Burbank, CA (US)

(73) Assignee: OPEN TELEVISION NETWORK, INC., Burbank, CA (US)

(21) Appl. No.: 13/666,951

(22) Filed: Nov. 1, 2012

Related U.S. Application Data
(62) Division of application No. 12/359,256, filed on Jan. 23, 2009, now abandoned.

(51) Int. Cl. G06F 15/16; G06Q 20/22

(52) U.S. Cl. 705/39; 709/219

(57) ABSTRACT

A system and method for providing digital media content involves use of custom URIs, disguised as URLs, provided as media enclosures in an RSS feed, for the purpose of redirecting requests for digital media content from a customer computer to an intermediate transaction server. The transaction server intercepts the custom URI containing customer, item, price and/or other relevant information to translate the file request into a transaction record and serve up the appropriate file, possibly from a remote merchant site, for the request and customer. When the transaction server receives a request for the custom URI, it parses it according to pre-defined rules and serves the appropriate file to the requester and records the transaction. This approach can be used to aggregate small transactions of digital content. Customers have a revolving account with the transaction server and can aggregate purchases from multiple merchants via RSS delivery up to preset limits.

### RELATED APPLICATION INFORMATION

This application is a divisional of U.S. patent application Ser. No. 12/359,256 filed Jan. 23, 2009, currently pending, hereby incorporated by reference as if set forth fully herein.

### BACKGROUND OF THE INVENTION

1. Field of the Invention

The field of the present invention generally relates to systems and methods for providing access to digital media content over a distributed computer network using a periodic feed such as an RSS feed.

2. Background

The advent of RSS (Really Simple Syndication) with media enclosures has provided a very popular method for delivery of content to RSS clients that handle media enclosures, allowing the availability of digital media content to remote clients over a distributed computer network such as the Internet. RSS was designed as a democratized delivery method, based on an extensible markup language (XML) formatted file. The client-side software (i.e., the RSS aggregator software running on the remote client computer) managing the file regularly checks the version of the file on the remote RSS server and compares it with the local copy on the client's computer. If there are changes then the client-side software will note the addition (or deletion) of enclosures and may automatically download them to the client's computer, depending on the settings in the software.

RSS feeds are often provided as part of a subscription service, whereby the client pays for access to the digital media content provided through the feed. However, RSS feeds generally have no way of associating a given customer with a download in order to record a transaction and serve up the appropriate media file. This limits the possible uses of RSS feeds.

It is possible, and relatively trivial, to control access to the RSS feed itself where either all content is available or no content is available. This access control is straightforward because scripts are supported for the generation of an RSS feed. In general, for this type of model to be practical, a subscription-based feed needs to come from only one content creator, needs to be produced regularly enough for subscribers to perceive value in an all-or-nothing subscription, and needs to be paid for in advance. However, it has not been possible in the past to allow customers to access only selected content from the feed for a content-specific fee.

A related problem with providing only selected content via an RSS feed is that existing mechanisms for charging customers for delivery of digital content are inadequate, in that a significant portion of available digital content would only merit a relatively small charge. The nature of the credit and debit card payment system, for example, with a combination of fixed and percentage-based charges can easily erode the profitability of transactions under $5 and effectively preclude charging very small amounts for digital content. This situation inhibits the purchase of discrete items of digital content, whether by using RSS feeds or otherwise.

There have been a variety of attempts to solve the problem of low value transactions. These attempts usually revolve around three approaches: pre-purchase of some form of special token or currency for use at specific websites that accept those tokens; billing small transactions to another payment system such as telephone accounts (a form of micropayment); or by aggregating transactions into amounts that can be charged profitably. Each of these approaches has its problems. Pre-purchasing tokens or special currency has a high user resistance, and accruing payment to existing accounts like those for a telephone has limited application to digital content delivery on the Internet. Accumulating to a monthly account carries risk for the merchant or micropayment service provider and carries the risk of a still-unprofitable transaction.

Further, each of these potential solutions requires some kind of added scripting inside the URL link provided for a download. In general, this link is used to write a transaction to a database and then provide a link for downloading the content. This leads to a variety of technical limitations.

RSS feeds will generally not work with these conventional approaches to providing low-value electronic transactions. For example, using a URL script to control access to a custom RSS feed is possible, but does not provide a means of charging for the delivery of content, only controlling access to the feed. As a result, the provider may have to charge in advance for a subscription period, whether or not there is any new content delivered during that period. Consumers, however, would not want to pay for a service during periods it is not being utilized, or to pay for a service in advance when unsure whether or not material will be downloaded or when only limited content may be downloaded.

It would therefore be advantageous to provide a means for overcoming one or more of the aforementioned limitations or drawbacks in the existing art. It would further be advantageous to provide a system and method for delivering digital media files to end users in an efficient and economical manner. It would also be advantageous to provide a system and method for delivering remotely stored digital media files to end users according to a subscription model, in an automated fashion with minimal intervention required by the end user.

### SUMMARY OF THE INVENTION

According to one or more embodiments, a method and system are provided for delivering digital media content using a periodic feed (such as an RSS feed) and allowing recordation of the delivered media content as a transaction. The method and system may involve associating a request for a URL of an enclosed media element with the customer and enclosure identification, so that the request for the file can be recorded as a transaction, and the appropriate media file served to the customer.

In one application, a digital media content delivery method or system may associate a single user account, with purchases, and file downloads from within a standard RSS subscription and standard software clients across a range of merchant providers. The method or system may create a uniform resource identifier (URI), or equivalent, with the customer identification, item identification, price, affiliate and other information encoded into the URI. The URI can be used in place of a media URL within the RSS feed. The file URI may be “disguised” so that the RSS aggregator software believes it to be a valid URL to a media file that it can download. A request for digital content from the client software is intercepted at an RSS transaction server and processed to record the transaction and serve up the appropriate content file to the customer. The RSS transaction server preferably does not reveal the actual media location, or URL, to the client device.

According to one aspect of a preferred embodiment, the processing of a digital media request occurs by intercepting the request and process that request for a media file, not by using pre-processing scripts. Thus, the file request alone is generally sufficient to generate all tracking of requests to users from the URI provided, and to serve up the appropriate media file.

According to another aspect of a preferred system for providing digital content to remote users, an efficient means is provided to allow consumers to pay for digital content, and particularly for numerous small purchases of digital content that might otherwise not be economical for merchants to process. Purchases may, for example, be aggregated on a revolving “credit” account, in the form of a “tab”, where the aggregation is kept only until profitable to process to a form of payment. The tab may be automatically renewed to allow future subscription purchases to be processed.

In accordance with another embodiment, a method is provided for intercepting a custom URL that encodes customer, item, price and/or other relevant information at the server, and for translating the file request into a transaction record and serving up the appropriate file for the request and customer. The use of custom URIs for downloadable items effectively abstracts the file transaction request from the delivery of the actual media item to the requesting software. When the server receives a request for the custom URI, it parses it in accordance with pre-defined rules and serves the appropriate file to the requester and records the transaction. This action can also be used to charge for small items of digital content purchased on a public network, allowing an efficient and secure means to charge for enclosure items in an RSS feed as they are downloaded. Items downloaded are preferably recorded to a simplified method of aggregating small value payments on an auto-closing, revolving account or tab. Customers provide their payment details once and can charge to their tab account transactions from multiple merchants via RSS delivery up to preset limits. Tab accounts can be acquitted and reopened automatically when they reach the preset limit.

Other embodiments, variations and modifications are also disclosed herein.

### BRIEF DESCRIPTION OF THE DRAWINGS

The present invention and its advantages may be better understood by reference to the drawings, wherein:

FIG. 1 is a process flow diagram illustrating an example of creating and validating a customer account.

FIG. 2 is a process flow diagram illustrating an example of processing a purchase request for one or more media items, in accordance with one embodiment of a digital media content delivery system as disclosed herein.

FIG. 3 is a process flow diagram illustrating an example of additional aspects of a purchase transaction using the inventive digital media content delivery system.

FIG. 4 is a process flow diagram illustrating an example of processing payment in connection with a purchase transaction for a digital media content delivery system, as may be used in connection with one or more embodiments as disclosed herein.

FIG. 5 is a diagram illustrating various functions or options that may be available to a merchant utilizing a digital media content delivery system.

FIG. 6 is a diagram illustrating various functions or options that may be available to a customer utilizing a digital media content delivery system.

FIG. 7 is a conceptual block diagram illustrating various system components that may be utilized as part of a digital media content delivery system, according to one or more embodiments as disclosed herein.

FIG. 8 is a more detailed block diagram illustrating a number of system components that may be utilized as part of a digital media content delivery system, in general accordance with the basic functions and arrangement illustrated in the system of FIG. 7.

FIG. 9 is a process flow diagram illustrating an example of processing a transaction for a digital media content delivery system, along with other functions or features, as may be used in connection with one or more embodiments as disclosed herein.

### DETAILED DESCRIPTION OF PREFERRED EMBODIMENTS

RSS feeds are often, as noted above, provided as part of a subscription service, whereby the client accesses the digital media content provided by the feed. However, RSS feeds generally have no way of associating a given customer with a download in order to record a transaction and serve up the appropriate media file. In a standard web browser, it would theoretically be possible to replace a URL linked to a media file with an executable script that records a transaction and serves up the media file. However, in practice this approach is problematic. For example, RSS 2.0 clients, which are not browsers, do not support scripts in place of media location URLs. Moreover, the applications and RSS specifications do not support scripts in the place of a linked file. Therefore, an alternative approach is necessary.

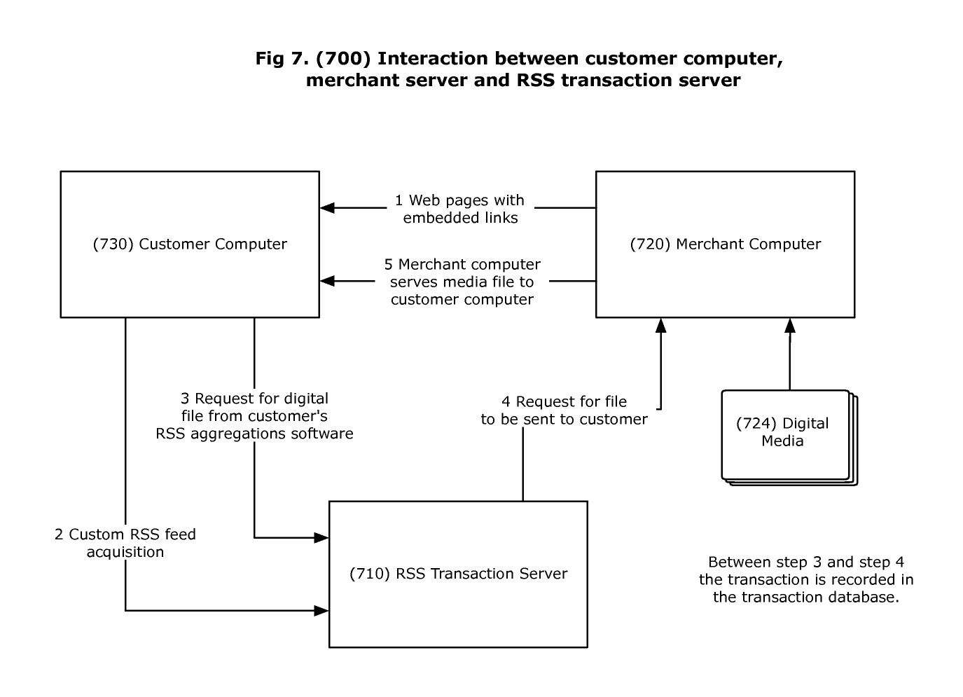

FIG. 7 is a conceptual block diagram illustrating a digital media content delivery system 700 and certain associated components thereof, according to one or more embodiments as disclosed herein, which overcomes one or more of the problems described herein and may provide additional advantages and benefits as will be apparent to those skilled in the art. In FIG. 7, the digital media content delivery system 700 comprises an RSS transaction server 710 that communicates directly or indirectly with one or more remote merchant computers 720 (only one of which is shown in FIG. 7) and one or more remote client or customer computers 730, over a distributed or wide-area network (WAN) such as, for example, the Internet, although alternatively some part of the communications may take place using a dedicated connection or other means.

In the embodiment shown, RSS feeds are not processed directly by the merchant computer 720. The merchant presents a prototypical RSS feed generated by the RSS transaction server. Rather, the RSS feed requests are transmitted from the customer computers 730 to the RSS transaction server 710. As explained in more detail hereinafter, the RSS transaction server 710 translates the RSS feed request to a custom RSS feed, and returns the custom RSS feed 764 to the customer computer 730 with custom URIs for each media item in the RSS feed. In a preferred embodiment, the operation thereafter varies depending upon whether a single digital media file or multiple digital media files are associated with the feed. A single digital media file 724 may be automatically downloaded from the merchant site to the customer's aggregation software, or otherwise made available to the customer computer 730 by other means. In a preferred embodiment, both single item downloads and multiple item downloads use an RSS feed, the main difference being that a single item download has only one item in the feed. Some RSS feed providers (e.g., iTunes) automatically download the “most recent” item in a feed, so a single item feed has an automatic download. When a multiple item feed is requested via such providers, the “most recent” item will be downloaded but it will be treated as a free item.

The actual request for the single digital media file 724 will be handled by the RSS transaction server 710, which interacts with the merchant computer 720. If multiple digital media files are associated with the custom RSS feed, then the merchant computer 720 may transfer the most recent digital media file 724 to the customer computer 730, and send an index or list of related content to the customer computer 730, allowing the customer to select which of the digital media files 724 to elect to download. Again, the actual request for the digital media file(s) 724 or index may be handled by the RSS transaction server 710, which interacts with the merchant computer 720.

Examples of applications for RSS feeds include such things as electronic periodicals, electronic content subscriptions (e.g., TV programs or videos made available on the Internet, digital comic books, music subscriptions, etc.), or other audio, visual or electronic print materials, where a merchant adds new content items periodically.

A system or method utilized according to the embodiment of FIG. 7 may allow a central RSS transaction server 710 to record transactions for digital media content, whereby the central RSS transaction server 710 accumulates transactions for a given customer over time, in the form of a running tab. At specified intervals or otherwise, the customer's account or tab is paid off either through an automated financial transaction (e.g., credit card or debit card transaction) or through other means, such as an e-purse transaction. A customer may also pre-pay to establish an account limit in advance.

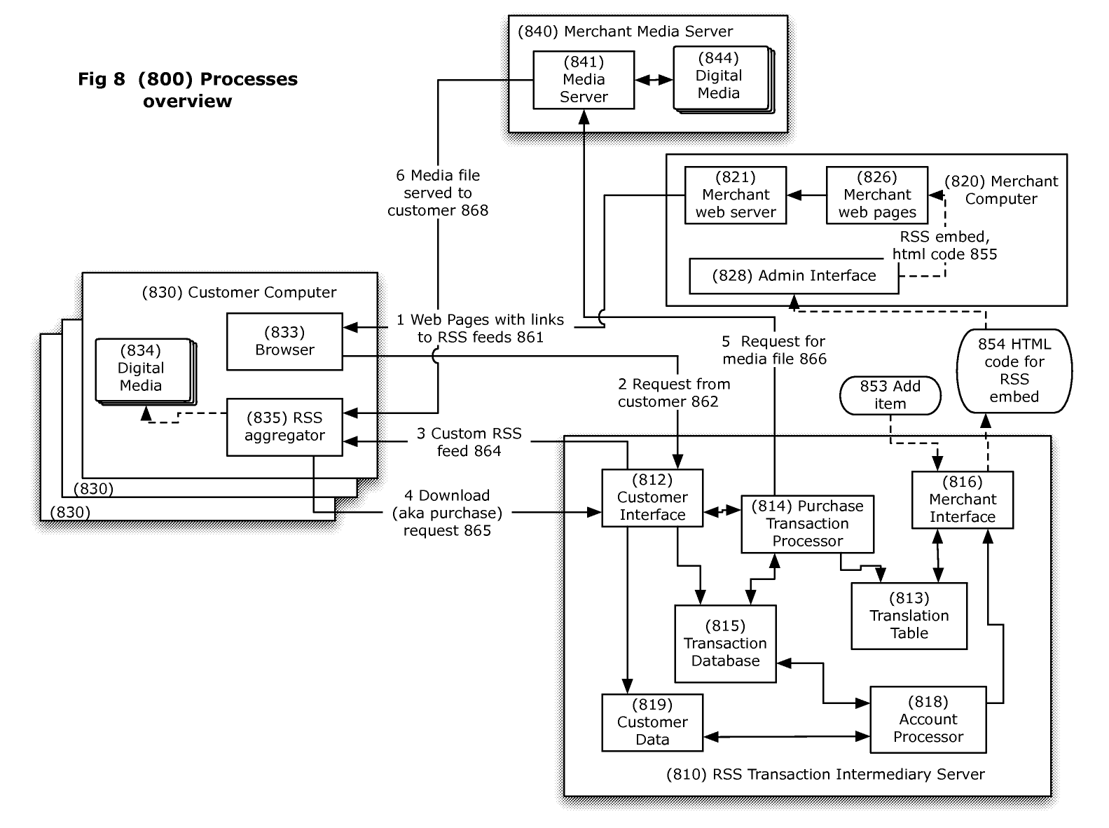

The operation of the FIG. 7 system can be explained in greater detail with reference to the digital media content delivery system 800 and associated components thereof illustrated in FIG. 8, which shows one possible implementation of the more general system depicted in FIG. 7. In FIG. 8, similar to FIG. 7, the digital media content delivery system 800 comprises an RSS transaction server 810 that communicates with one or more remote merchant computers 820 (only one of which is shown in FIG. 8) and one or more remote client or customer computers 830, over a distributed or wide-area network (WAN) such as, for example, the Internet, although, as noted before, alternatively some part of the communications may take place using a dedicated connection or other means. The merchant computer(s) 820 are generally associated with web sites which may be visited by customers or potential customers via, e.g., a web browser 833 or equivalent. In this example, the digital media 844 to be provided to customers is located at a remote merchant server site 840, although in other embodiments the digital media 844 may be located at the merchant computer 820 or at other locations.

In the embodiment of FIG. 8, a merchant desiring to provide digital content using RSS feeds sets up one or more web pages 826 which provide embedded URLs referencing the RSS transaction server 810. Each embedded URL associated with an RSS feed preferably includes the items that merchant has entered into the RSS transaction server database and identifying information about the feed such as: the XML declaration; channel information; feed information such as title, description and link to a website; and content items from those listed in the RSS transaction server data base.

The merchant accesses the RSS intermediate computer 810 through a merchant interface 816, and, as explained in more detail later, may enter product information that is then stored in, among other possible locations, a translation table 813 at the RSS transaction server 810. The translation table 813 enables rapid parsing of content requests and conversion into custom URIs in response to the customer requests. Upon adding each item or group of items to the RSS transaction server 810, the RSS transaction server 810 makes available HTML code 854 that includes the embedded URL referencing the RSS transaction server 810. This HTML code 854 is provided by the RSS transaction server to be embedded in the merchant's web page(s) 826 referencing the digital media product(s). This process can be carried out by a web administrator at the merchant computer 820, or else an automated process may be provided.

When a customer visiting the merchant web site, and having loaded the merchant web page(s) 826, selects the embedded URL, the request 862 is directed to the RSS transaction server 810 by virtue of the address included as part of the URL. The request 862 preferably includes a request for the specified feed items, or provides an RSS feed that matches a search criteria across the RSS transaction server database. A search across the RSS transaction server database will create a custom RSS feed from multiple merchants.

The RSS transaction server 810 translates the request for a RSS feed to a custom RSS feed, and returns the custom RSS feed 864 to the customer computer 830. The custom RSS feed 864 preferably includes all of the feed information such as: the XML declaration; channel information; feed information such as title, description and link to a website; and content items from those listed in the RSS transaction server database and additional information about each media item, encoded into a custom URI for each media item. The custom RSS feed 864 may, for example, contain custom URIs for each enclosure item that is associated with the feed request, or else each enclosure item that matches rules in the RSS transaction server 810 to identify the feed request. The actual customer information, item identifier and other information tracked to the purchase, such as (but not limited to) affiliate code and price, are encoded within the URI and obscured.

The contents of the media enclosure URI may take the following form:

enclosure=Base64.encode64(check+“,”+@customernum+“,”+@affil.to_s+“,”+product.id.to_+“,”+product.price.to_s+“,”)

which correlates to the following fields: checksum, customer number, affiliate ID (if any), product ID, and product price. The suffix on the file is preferably set to “.mp4” to make it a readable media item that can be downloaded.

These custom URIs, contained with the custom RSS feed 864, are processed so that the RSS aggregator software 835 at the customer computer 830 believes them to be valid media file URLs. In other words, the custom URIs are provided in a format compatible with the RSS aggregator software 835, such that the RSS aggregator software 835 interprets the customer URIs as representing a media file that is capable of being downloaded by the RSS aggregator software 835. The file URI is thus presented to the customer's RSS aggregator software 835 as a media file. When the customer's RSS aggregator software 835 makes a request for the media file, the request is interpreted by the RSS transaction server 810 and the details are recorded in a transactions database 815 at the RSS transaction server 810.

In a preferred embodiment, the operation thereafter varies depending upon whether a single digital media file or multiple digital media files are associated with the RSS feed. A single digital media file 844 may be automatically downloaded from the merchant site to the customer's RSS aggregation software 835, or otherwise made available to the customer computer 830 by other means, as described in more detail below. If multiple digital media files 844 are associated with the custom RSS feed 867, then the merchant computer 820 may transfer the most recent digital media file 844 to the customer computer 830, and may send an index or list of related content to the customer computer 830, allowing the customer to select which of the digital media files 844 to elect to download. For a single digital media file, the customer may confirm the desire to purchase in the form of a purchase request 865, by, e.g., clicking on the link provided in the URI of the custom RSS feed 864. If multiple digital media files are associated with the RSS feed, the customer may copy the URL in the custom RSS feed 864 to the RSS aggregator software 835, or otherwise may click on the link provided in the customer RSS feed 864. In that case, the RSS aggregator software 835 or customer action will cause a download request 865 to be communicated to the RSS transacation server 810 where it is interpreted as a purchase request.

When the RSS transaction server 810 receives a download request 865, it transfers the request to a purchase transaction processor 814 routine, which converts the custom URI embedded in the pseudo media file request 865 to the location of the desired media file at the merchant media server site 840, using the information stored in the translation table 813. At that point, the RSS transaction server 810 may provide a link 866 to the digital media file to the RSS aggregator software 835. The actual location of the digital media file 844 at the merchant media server site 840 may be hidden from the customer computer 830 according to conventional techniques. Alternatively, the RSS transaction server 810 may send the request for the digital media file to the merchant media server site 840, and include the customer computer URL such that the digital media file is provided to the customer computer 830. In other embodiments, the RSS transaction server 810 may receive the digital media file from the merchant media server site 840 and convey it to the customer computer 830 making the request therefor.

Examples of customer RSS aggregator software 835 that may be used in the system 800 of FIG. 8 include Itunes® (available from Apple Corp.), Zune Marketplace® (available from Microsoft Corp.), and Miro™ (an open source RSS product from the Partcipatory Culture Foundation), for example.

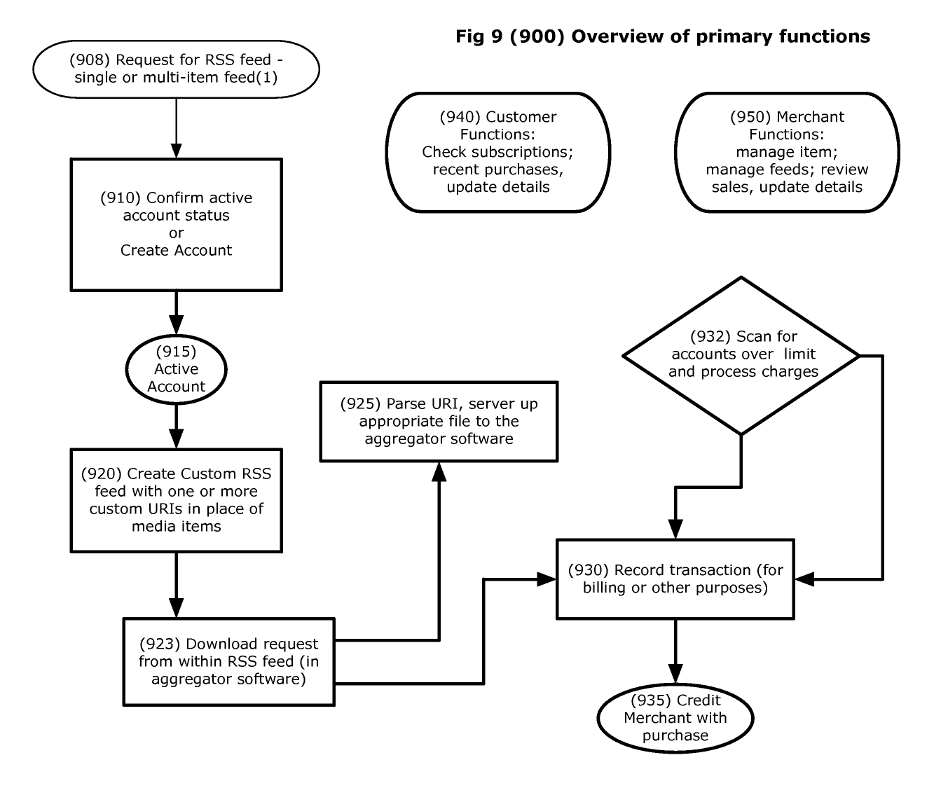

FIG. 9 is a process flow diagram 900 illustrating an example of processing a transaction for a digital media content delivery system, along with other functions or features, as may be used in connection with one or more embodiments as disclosed herein, such as the embodiment of FIG. 8. When a customer clicks on or otherwise selects a purchase link (for either a single item feed or a multi-item feed), as represented by step 908, the customer is presented with a screen requesting that the customer enter his or her User Name and Password, as indicated by step 910. The initial customer validation screen may be generated by HTML instructions 855 contained in the merchant's web page 826 (originally obtained when entering the product information via the merchant interface 816, as previously described). Alternatively, the customer validation screen code may be located at the RSS transaction server 810, and may be triggered when the customer is routed to the RSS transaction server 810 in response to selecting one of the product links on the merchant's web page.

If the customer has no User Name, the customer is directed to open an account, which initiates a session with the RSS transaction server 810 for such a purpose, as described in more detail later herein. If, on the other hand, the customer has a User Name and Password for the system, then after entry of such information the customer's account status is checked, as indicated by step 915. If the customer has an active account and credit in good standing, the process continues; however, if the customer has an account but it is not in good standing, the customer is directed to a Bad Account Action Page for further action.

Next, in step 920, assuming that the customer's account is active and has credit in good standing, the RSS transaction server 810 generates a custom RSS feed 864 with one or more custom URIs in place of the media items specified by the customer's selection at the customer computer 830. More specifically, the customer's selection of one or more media items listed on a merchant web page 826 is conveyed in the request 862 to the RSS transaction server 810, which stores the information pending verification of the customer's account and status. Once the account is verified, the stored information is used to generate the custom RSS feed 864 that includes a custom URI for each media item associated with the request 862, as indicated by step 920. The custom RSS feed 864 is sent from the RSS transaction server 810 back to the customer computer 830, where it is processed by the RSS aggregator software 835. The customer's RSS aggregator software 835 is either presented with a single item RSS feed that appears to the customer as a download link due to the default behavior of some aggregator software (if a for single digital media item) or else an RSS feed if the request relates to multiple digital media items. Each digital media item in the RSS feed has it's own associated descriptive information and a custom URI masquerading as a valid media file link.

Next, as indicated by step 923, a download request from within the aggregator software 835 is sent from the customer computer 830 to the RSS transaction server 810. In step 925, the RSS transaction server 810 parses the custom URI contained in the custom RSS feed 867 (originally supplied by the RSS transaction server 810 in response to the customer request 862), and, after translation, relays the request for the appropriate media file 844 to the merchant media server site 840 (or alternatively the merchant computer 820) along with an identification of the customer computer 830. At the same time, as indicated by step 930, the RSS transaction server 810 records the transaction in the transaction database 815, allowing the customer to be charged and the merchant to be paid for the digital media at a later time. The selected digital media file 844 is downloaded from the merchant media server site 840 or merchant computer 820 to the customer computer 830, based on the request sent from the RSS transaction server 810.

Periodically, as generally indicated by step 932 in FIG. 9, customer accounts are reviewed and processed so that accumulated charges can be cleared and the merchant can be paid for providing the content to various customers. The RSS transaction server 810 includes an account processor 818 which reviews information in the transaction database 815 and carries out any necessary financial processing in order to clear the customer's account and pay the appropriate merchants. In one embodiment, the account processor 818 of the RSS transaction server 810 scans customer accounts for charges over a specified credit limit, e.g., $5 or $10. Such charges may have been accumulated for digital content received from different merchants and different merchant computers 830. These charges across different merchants may be aggregated into a single financial transaction with a financial institution—for example, using a credit card or debit card type transaction. By aggregating small transactions into a single larger transaction, the fixed fees charged by financial institutions are much less significant than they otherwise would be. When the transaction has been completed, the merchant(s) may be credited with the appropriate amounts for the customer purchases (as indicated by step 935 in FIG. 9). In some cases, a commission (percentage or fixed fee) may be charged by the provider of the RSS transaction server 810 for the services of the system.

In some situations, a customer may not make enough purchases within a given period to justify an economic financial transaction with the financial institution. Nonetheless, to avoid account latency, the RSS transaction server 810 may nonetheless process any customer account that has not been processed for a certain amount of time, e.g., for 2 or 3 months. In this way, the company supporting the RSS transaction server 810 does not have to carry large amounts of unacquitted credit, even if a particular customer makes only infrequent purchases. Ideally, the number of customers making larger-scale purchases will be sufficient to offset the effect of customers who make only infrequent purchases and who therefore require larger percentage financial transaction charges. The account processor 818 may be optimized to take account of historical purchase patterns of customers, so that, for those who purchase larger volumes with a history of good account usage, processing will be delayed for an additional period of time, or alternatively until their account reaches their typical monthly level. This optimization may make such customers more profitable by reducing the relative impact of the fixed fees charged by financial institutions.

Within the system 800, two types of custom RSS feeds can be supported: a feed with multiple media items, and a feed with only one media item. For single-item custom RSS feeds, the digital media file 844 is transferred from the merchant computer 820 to the RSS aggregator software 835 of the customer computer 830. A single item feed thus contains only one enclosure. A multiple item feed may contain two or more enclosure items and, in a preferred embodiment, provides for previews to be viewed freely by the customer via the RSS aggregator software 835.

Each item for sale in the system is supplied with a single-item URL to facilitate direct purchase and download from a merchant website 820 to the customer's RSS aggregator software 835. The RSS transaction server 810 records the purchase with the download once the customer enters their email address and user name and confirms the purchase as previously described. The RSS transaction server 810 creates a custom URI for the requested item in a single item feed, and sends the feed to the customer's RSS aggregator software 835 of choice. When the RSS aggregator software 835 receives the RSS feed, its default behavior is to download the most recent time in the feed. When there is a single item in the feed, the RSS aggregator software 835 sends a request to the RSS transaction server 810, which interprets the request for a media file, records the transaction in the transaction database 815, and provides the true download link to the customer's RSS aggregator software 835. The RSS aggregator software 835 then downloads the media item 844 for the customer, from the merchant media server 840.

An RSS subscription request may not necessarily incur charges until items are downloaded. For an RSS subscription request, a custom feed URL is created for each customer and item, and the custom feed URL is dynamically regenerated each time the RSS feed is updated by the merchant through the merchant interface 816 on the RSS transaction server 810. Each time the feed is generated, the customer's status is confirmed using the same process earlier described, i.e., the customer enters his or her User Name and Password information into a verification screen. If the customer does not have an active account when the URL is checked, the items in the enclosure feed are not displayed until the account is reactivated, so no purchase is possible.

The custom feed for an RSS subscription request contains custom URIs for each enclosure item that matches rules in the server to identify the account and file request. As noted previously, the actual customer information, item identifier and other information tracked to the purchase, such as affiliate code and price or other information, are encoded within the URI and obscured. This custom URI is processed so that the RSS aggregator software 835 believes it to be a valid media file URL within the RSS subscription feed.

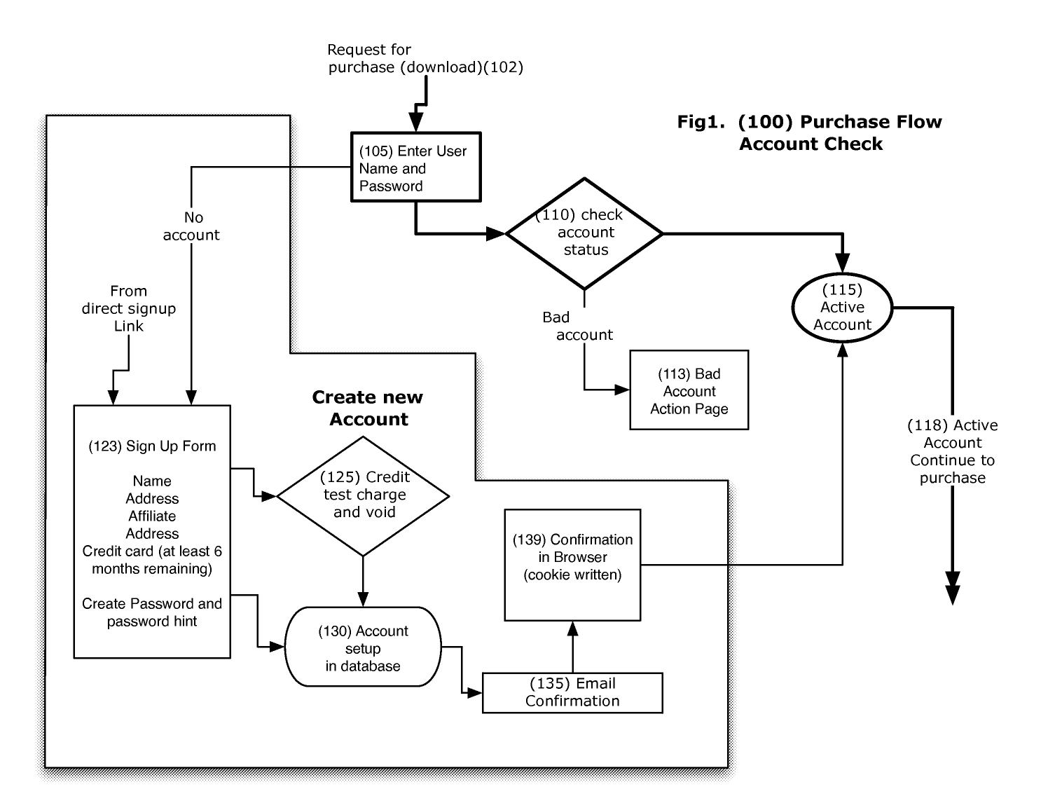

Further details will now be described of specific process flows and other system functions and features, as illustrated in FIGS. 1 through 6, and as may be used in conjunction with one or more embodiments as disclosed herein. The examples of FIGS. 1 through 6 are generally explained with reference to the embodiments illustrated in various levels of detail in FIGS. 7, 8 and 9, but the process flows may be used in connection with other embodiments as well.

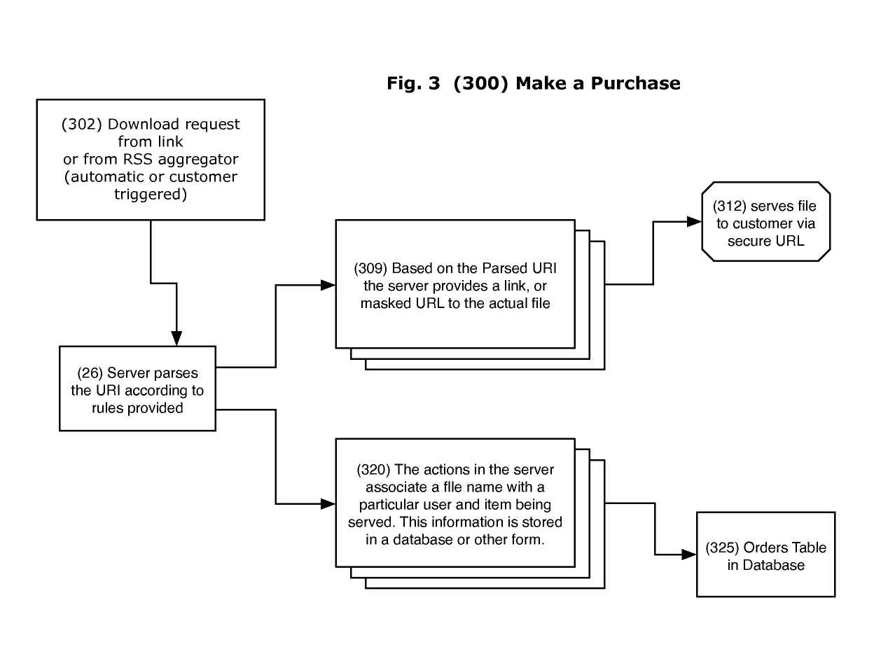

FIG. 1 is a diagram illustrating an example of a process flow 100 for, among other things, creating and validating a customer account. When, in response to an offer on a merchant webpage or some other source, a customer clicks on a purchase link for either a single item feed or a multi-item feed, the customer request is conveyed from the customer computer (e.g., 730 in FIG. 7 or 830 in FIG. 8) to the RSS transaction server (e.g., 710 in FIG. 7 or 810 in FIG. 8). The incoming request for a purchase (download) is indicated by step 102 in FIG. 1. In step 105, in response to the customer's request, the customer is presented with a screen to enter his or her User Name and Password. This screen may be generated by sending a validation request to the RSS transaction server 810. If the customer has no User Name, then the process directs the customer to open an account, as indicated generally by a Create New Account process 120. If, on the other hand, the customer has a User Name and Password for the RSS transaction system, then that information is transmitted to the RSS transaction server 710 or 810, which checks the customer's account status, as indicated by step 110. If the customer has an active account and credit in good standing, the process continues to a purchase routine, as indicated by step 118 and as detailed herein after (see FIG. 3). If the customer has an account but it is not in good standing, the customer is directed to a Bad Account Action Page, as indicated by step 113, whereupon further action may be taken or else the transaction may be refused.

If there is no active account, or the customer has requested to create an account, then the customer is taken to a signup form at the RSS transaction server 810, as presented by the customer interface 812, that describes the service and conditions, as indicated by step 123. The customer may be asked to provide information such as name, address, email, and credit card (preferably with an expiration date sufficiently far into the future). The customer is also asked to create a User Name (or else this may default to the customer's email) and Password, along with, if desired, a password hint. The customer fills in the form and submits it. In response, a customer account is set up as the RSS transaction server 710 or 810 (see also customer data repository 819 in FIG. 8), as indicated by step 130. The customer's account details are stored as a record in the customer database and encrypted. As indicated by step 135, a confirmation email may be sent by the RSS transaction server 710 or 810 to the supplied email address to verify the accuracy of the email address for security and billing contact purposes.

At the same time, as indicated by step 125, a test charge may be made to the customer's supplied credit card, and immediately voided if successful. No advance charge is made to the customer account in this embodiment.

When the customer completes the link back from the email, confirming the validity of the email address, a cookie is written to the customer's computer and a confirmation of account is returned to the customer in their browser, as indicated by step 139. The customer is now considered to have an active account, and the customer's first tab is opened. At this point, the process may proceed to step 115, and onward to the purchase transaction processing.

When a customer attempts to add a single item to his or her tab, the customer's status is preferably confirmed as described above. Purchases are based on RSS feeds. Within the system two types of feeds are supported: (1) a feed with multiple associated media items and (2) a feed with only one associated media item. In a preferred embodiment, a single item feed generally contains no preview and only one enclosure. A multiple item feed may contain many enclosure items and provides for previews to be viewed freely.

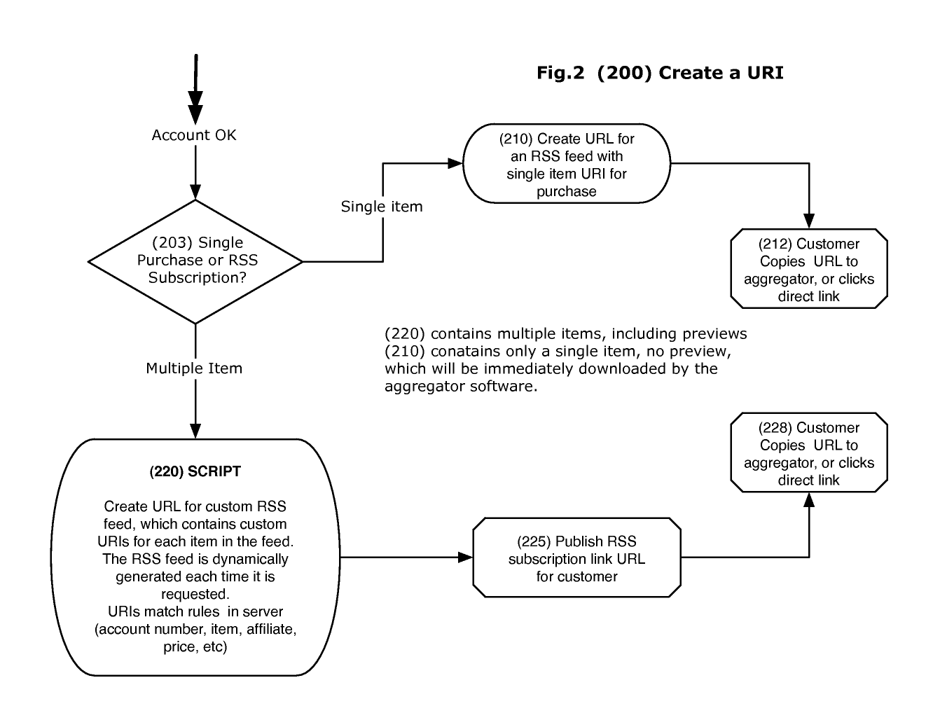

FIG. 2 is a process flow diagram illustrating an example of processing a purchase request for one or more media items, in accordance with one embodiment of a digital media content delivery system as disclosed herein. Each item for sale in the RSS feed transaction system is automatically assigned a single-item URL to facilitate direct purchase and download from a website to RSS aggregator software. The details of process 200 will be explained with reference to the embodiment of FIG. 8, although it may be applied to other embodiments or system configurations as well. If the customer desires to purchase a single item, the process branches to step 210. In response to the customer request to purchase a single item, the RSS transaction server 810 creates a custom RSS feed with single item URI (or equivalent) for purchase. The URI preferably contains the customer identification, item identification, price, affiliate identifier, and possibly other information, all encoded into the URI. The customer identification is based on the customer account, while the item identification, price, and affiliate identifier may, for example, be received from the customer purchase request or else looked up in a local table at the RSS transaction server 810. The single item URI generated by the RSS transaction server 810 is used in place of a media URL within the single-item RSS feed. The file URI is “disguised” so that the RSS aggregator software 835 at the customer computer 830 believes it to be a valid URL to a media file that it can download. The system preferably does not reveal the actual media location, or URL, to the customer computer 830 until after recording a transaction into the transaction database, and even then only provides it in a manner not accessible to the user.

The RSS transaction server 810 creates a custom URI for the requested media item in a single item feed, and sends the feed to the customer's RSS aggregator software 835 of choice at the customer computer 830. The RSS feed containing the purchase is created with the customer's custom download URI for the feed once the customer enters his or her email address and user name and confirms the purchase. When the RSS aggregator software 835 at the customer computer 830 receives the RSS feed containing only a single item, the default behavior is to download the item. At the time the download request is received at the RSS transaction server 810 the transaction is recorded and the media item is served by the RSS transaction server 810 to the customer's RSS aggregator software 835. Payment is processed as described later herein.

For an RSS Subscription request, the process 200 in FIG. 2 branches to step 220. An RSS Subscription request preferably incurs no charges until items are downloaded, whether for a single item or multiple item feed. In response to an RSS Subscription request, the RSS transaction server 810 preferably creates a custom feed URL for each customer and item, as specified in more detail below, with the custom feed URL being dynamically regenerated each time the feed is updated. Each time the feed is generated, the customer's account status is confirmed (per FIG. 1). If the customer does not have an active account when the status is checked, the items in the enclosure feed are not displayed until the account is reactivated, so no purchase is possible.

The custom feed associated with an RSS Subscription request is RSS-compliant but at the same time differs from a conventional RSS feed in that it contains custom URIs having specific encoded or embedded information disguised as media file URLs. In particular, the feed contains custom URIs for each enclosure item that matches rules in the RSS transaction server 810 to identify the account and file request. When the RSS aggregator software 835 requests a “media file” the request goes to the RSS transaction server which uses the encoded references to identify the customer and the media file to be served. The actual customer information, item identifier and other information tracked to the purchase, such as (but not limited to) affiliate code and price, are encoded within the URI and obscured. Similar to the single-item purchase, each custom URI associated with an RSS subscription request is processed so that the RSS aggregator software 835 at the customer computer 830 believes it to be a valid media file URL.

As indicated in step 225 of FIG. 2, the RSS subscription URL is published to the customer to subscribe to in the RSS aggregator client software 835 at the customer computer 830. In practice the embedded link in the RSS feed automatically directs the subscription to the customer's preferred RSS aggregator software 835. For example, links to cause the automatic open iTunes aggregator software start with itpc://anrssfile.xml (this link will always try to open in iTunes on an Apple Macintosh or Windows PC computer). The customer copies the URL to the RSS aggregator software 835, where the customer can then select the appropriate media file in order to download the requested media file, as indicated by step 228.

Subscribing to either type of RSS feed, i.e., single-item or subscription, requires the customer to confirm his or her email address and password, through the process flow of FIG. 1, to validate the customer's identity and confirm agreement to pay for the purchase. Validation of customer details preferably happens on the first subscription to the feed and each time the feed is refreshed (daily by default in most conventional aggregator software). The customer details can be subject to validation again when an item is requested for download, to accommodate the possibility of a customer's status having changed since the feed was requested. However, in this embodiment, the only time the customer actively validates their account is when the customer first subscribes to the single or multiple item RSS feed.

When the RSS aggregator software 835 issues a download request based on the URL provided from the RSS transaction server 810, or else when the customer clicks/selects the URL, the request embedded within the URL is conveyed back to the RSS transaction server 810. This process is illustrated in more detail in FIG. 3. As indicated by step 302, when the RSS transaction server 810 receives a download request for one of the custom URIs in an RSS subscription (whether from a single item feed or else one item within a multi-item feed, and whether automatically downloaded from the RSS aggregator software 835 or else user-triggered), then the RSS transaction server 810 intercepts the call for a “media file” and, as indicated by step 305, parses the URI according to rules established within the RSS transaction web application within the purchase transaction processor 814.

The RSS transaction web application at the RSS transaction server 810 parses all the relevant information from the URI and then does the following. First, the RSS transaction web application checks the customer's account status and financial standing within the RSS transaction system, by querying customer data repository 819. Assuming that the customer has an active account in good standing, the RSS transaction web application then, as indicated by step 309, determines the appropriate file to serve to the customer, which can be the same for all customers or else could be different files to different customers based on a different rule in the web application. For example, depending upon a customer's geographic location, one customer may get a link to content in a different language than another customer. The RSS transaction web application then sends a link to the media file to the RSS aggregator software 835 at the client computer 830, as indicated by step 312.

If the request is for a single item, then a RSS feed with a single media file enclosure it will be created. When the RSS aggregator software 835 on the client computer 830 receives the single item RSS feed, the default behavior of the RSS aggregator software 835 is to automatically download the “most recent” item (in this case the only item) to the client computer 830 from where it is stored. If the request if for multiple items, an index or list of items associated with the feed may be returned to the client computer 830, and the customer may then select the desired items via the RSS aggregator software 835. In some cases (e.g., ITunes), the client RSS aggregator software 835 may automatically download the most recent media item in addition to providing a list of available items.

Concurrent with the processing of the custom URI and serving of the media file to the customer, the RSS transaction server 810 records a transaction to the transaction database 815 or other relevant data structure, with the relevant details from the parsed URI.

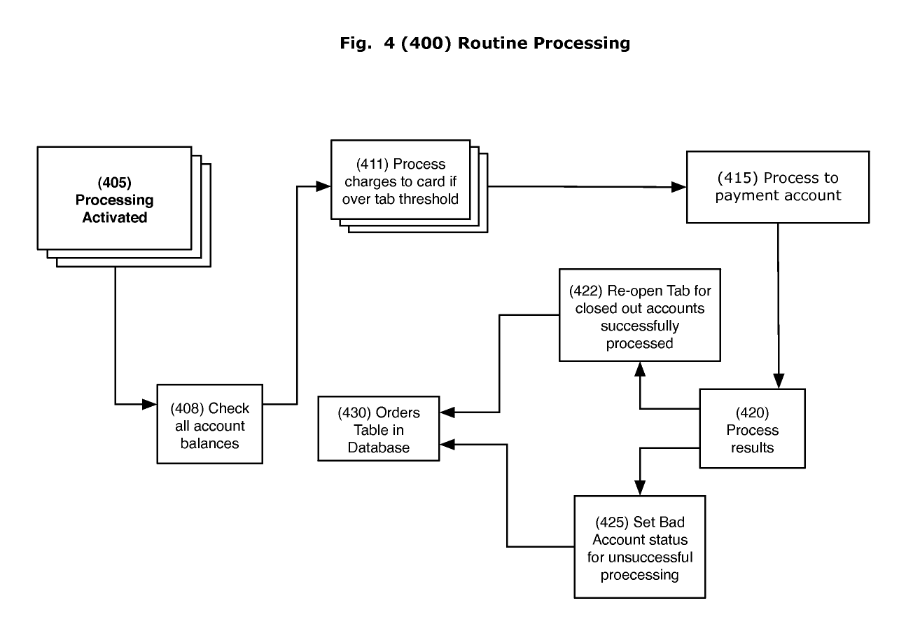

At routine intervals, processing of recorded transactions is carried out, as illustrated by the exemplary process 400 depicted in FIG. 4. This process may be referred to as tab processing. According to this process, tab processing may be activated, as indicated by step 405, at periodic intervals (e.g., monthly) or else on certain triggering events, such as when a customer tab exceeds a certain preset level, or some combination of both. An account processor 818 is responsible for processing the customer tabs. Account balances are checked across all active customer tabs in the orders table of the transaction database 815, as indicated by step 408. Charges on tabs that are over the predetermined levels for the specific customer are processed, step 411, and the results of the processing (415) returned for interpretation (step 420). The processing step 411 may involve, for example, a charge to a customer's credit card, debit card, or e-purse, or some other similar financial transaction. If the balance for a given customer was successfully processed, then that customer's tab is immediately reopened for further purchases, as indicated by step 422. If, on the other hand, the processing was unsuccessful, the financial standing for the customer's account is set to “Bad Account” and a new tab is not opened, as indicated in step 425. The results are recorded in a database such as the customer data repository 819 (see step 430) and, insofar as financial transaction results, in a database associated with the account processor 818. Merchant accounts may be credited periodically (e.g., once a month) regardless of whether the customer accounts have been cleared, or alternatively may be credited after a customer payment transaction has been completed.

In one aspect, operation of the RSS transaction system may allow digital media files or other subject matter having relatively low sales cost (e.g., $0.50 or $1.00 apiece) to be aggregated into larger financial transactions, thereby saving costs for merchants who would otherwise have to pay higher per-transaction or percentage fees in order to process many small transactions. The RSS transaction system may deduct a fee for the service it provides to merchants in connection with aggregation processing. Note that the tab processing may allow transactions for a single customer across multiple different merchants to be aggregated into a single financial transaction. By contrast, a single merchant would not be able to offer items from multiple merchants that match a customer's potential search criteria because a single merchant only controls content from their server, whereas customers can create RSS feeds based on interest or content across multiple merchant providers.

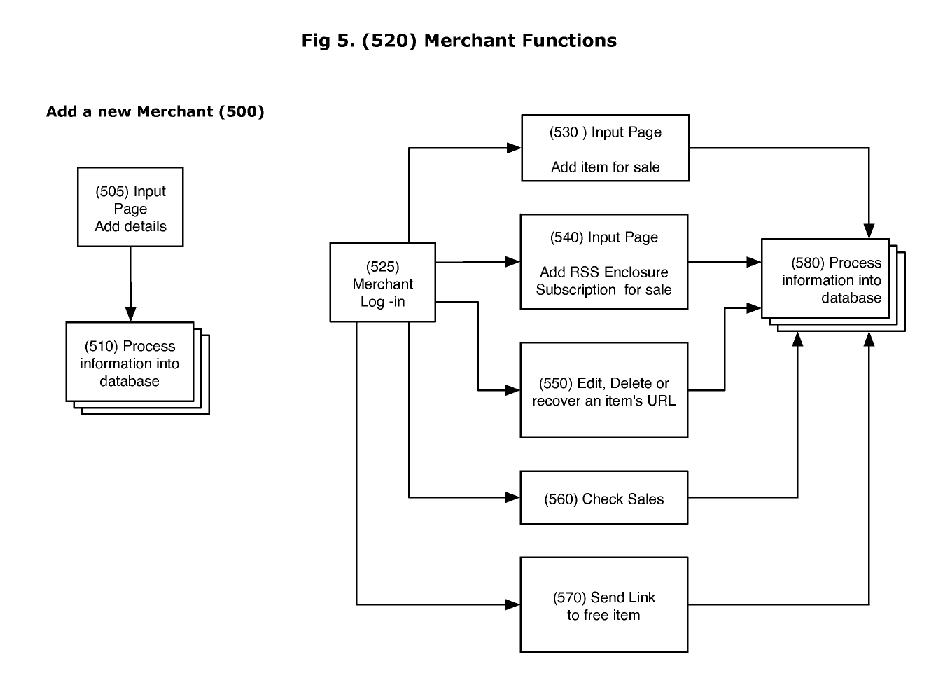

FIG. 5 is a diagram illustrating various functions or options that may be available to a merchant who intends to utilize a digital media content delivery system (i.e., the RSS transaction system) such as those shown in FIG. 7 or 8 for example. Preferably, any content-owning vendor can add itself to the RSS transaction system by remotely accessing the merchant interface 816 of the RSS transaction server 810, and proceeding to a merchant input page (step 505) and entering the appropriate information into a merchant database or similar data repository (step 510). Through such processing, the merchant may set up an account with the RSS transaction server 810.

Merchants with an account can log in (525) and from there perform a variety of different tasks. For example, as shown in 530, the merchant may add a new item for sale. Such an item is not available to consumers until an RSS feed has been established for the item. Thus, in 540, the merchant may add a new RSS feed and add the media enclosure item for sale to one or more pre-programmed RSS feeds. To do this, the merchant may fill out an electronic form that requests information concerning the RSS feed such as the declaration of the file as XML, the RSS channel the feed belongs to; the name of the feed, the merchant and feed description. The merchant also fills out information about specific digital media items for sale, including the URL location of the digital file(s) at the merchant computer (or other remote computer), the price for each item, the name of each item, a preview file associated with the item (if desired), and any other pertinent information. The merchant may include a variety of information about the digital file that may be loosely described as metadata; for example, the item's title, genre, publisher, length/duration (if applicable), media type, keywords relating to it, and so on. The metadata can, for example, allow customers to search for specific media data at a later time to create a custom RSS feed across merchants. The RSS feed(s) created by the merchant for their content is automatically associated with the merchant entering the information. The product information entered by a merchant is stored in, among other places, a translation table 813 in the RSS transaction server 810. The translation table 813 enables rapid parsing of content requests and conversion into custom URIs in response to the customer requests. Such content requests are not limited to a single merchant.

A merchant can also query, edit or delete an existing item, and may, for example, retrieve an item's URL upon request, as indicated by 550. The merchant may also check sales activity via the merchant interface 816, which in turn accesses data stored in the account processor 818. The merchant may also provide a link for a free item, as indicated by 570. Even free items are preferably processed through the system and recorded at the RSS transaction server 810 in a manner similar to chargeable items. If the customer account is not in good standing, no items will appear in the feed, or the download request will be denied. Thus, a customer account in good standing is preferably required for every download request All merchant requests are processed and, as noted, added to the relevant database (step 580).

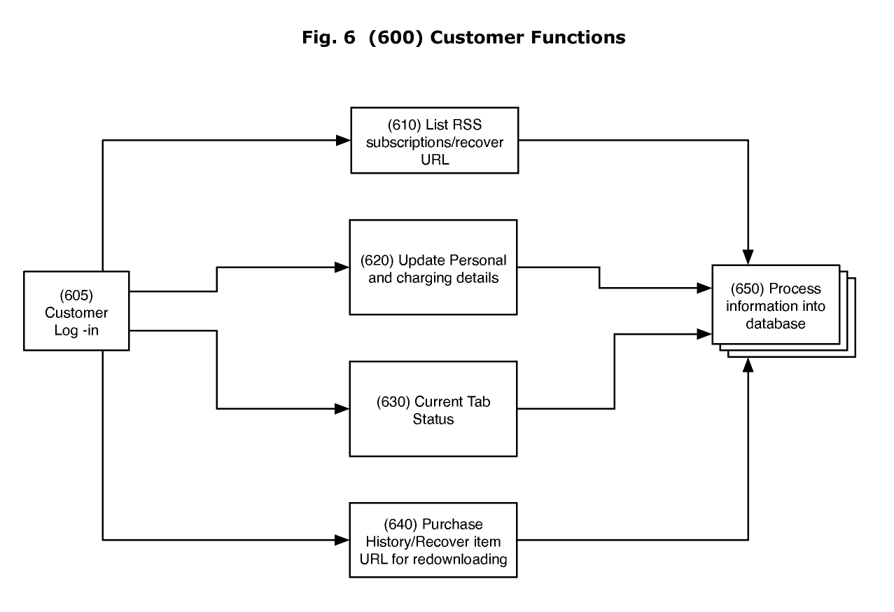

FIG. 6 is a diagram illustrating various functions or options that may be available to a customer utilizing a digital media content delivery system (i.e., the RSS transaction system) such as those shown in FIG. 7 or 8 for example. The customer remotely accesses the RSS transaction system via a customer interface 812 and, as indicated by 605, responds to a customer log-in screen which verifies the customer's identity with User Name and Password. After verification, customers can take any of a variety of actions, including, for example, obtaining a listing of RSS subscriptions to which the customer is subscribed (610). The customer may also update personal or charging information (620), which is stored in the customer data repository 819. The customer may also view the status of his or her current tab, as indicated by 630. This information would typically be retrieved from the customer data repository 819 or alternatively the transaction database 815. Lastly, the customer may review his or her purchase history or re-download an item that had been previously purchased (640). As with the merchant functions, all requests are processed and added to the relevant database (650).

In operation, a customer browsing the Internet would be exposed to a system-specific button as a purchase option on a merchant website or else discover an RSS feed that can be subscribed to in a directory. When the customer clicks on that link to make a purchase, the customer is either asked to confirm the purchase with the User Name and Password they have established with the system, or offered the opportunity to create an account by being taken to the starting page. These processes are shown in FIG. 1, described earlier.

For security creating an account is preferably a two-step process. The first step requires a customer to enter their personal details and a valid credit card with at least a certain period of time (e.g., 6 months) remaining before the credit card expires. Once entered, the details are posted in the customer data repository 819 and a confirmation email is sent to the customer's supplied email address. The email to the customer preferably contains a validation link that ensures the validity of the supplied email.

The RSS transaction server 810, via the account processor 818, preferably makes a test charge to the customer's supplied credit card for a nominal amount, such as US$1. If the charge is successful, it is immediately voided and no charge appears on the customer's statement.

At the same time, an initial tab, with a preset spending limit, is opened for the customer to begin charging items to their account. The spending limit may be based on a default setting for the RSS transaction server 810, or may be based on other factors, and may be periodically updated based on information including the customer's past payment and account history.

The RSS feed allows dynamic content indexes to be presented to the customer. The customer can review a list of content available in the RSS feed, and may select which items, if any, to preview and/or purchase, according to conventional selection tools available in RSS aggregator software 835. Previews are processed through the RSS transaction server 810, but with a price of $0. To make a purchase, the customer locates the item, show or feed that the customer desires to purchase. After clicking a system-specific purchase or subscribe button, customers fill in their email address and password. The RSS transaction system preferably provides a browser “cookie” so that these details are automatically filled in on one specific computer until the customer logs out from the system. Once the email address and password are confirmed, the customer will receive, from the RSS transaction server 810, a dynamically generated custom RSS feed with either a single item, or a multi-item feed containing custom URIs for all the media enclosures available for purchase through that RSS feed. Details of generating the custom URIs were previously explained with respect to FIG. 2.

These custom URIs contain customer information, item information and other useful information (such as—but not limited to—price and affiliate code) and are not directly related to the actual media file requested. Clicking the custom URI for download completes triggers the RSS transaction server 810 to process the request and serve up the purchase for the customer. Because the RSS transaction system tracks items at the customer level, items in an RSS feed through this system can come from multiple merchant content providers, and purchases can be credited to the appropriate merchant content owner/provider.

By using this method of masking the true URL and parsing it at the RSS transaction server 810, the RSS transaction system is able to provide security, convenience, the ability to charge for individual digital media items, and remain entirely compatible with all RSS aggregator software functions while recording (for charging or other purpose) only the files downloaded.

When the customer's aggregator software 835 downloads an enclosure from the custom RSS feed, the request for the URI is sent to the RSS transaction server 810 where it's parsed by rules established at the server. Based on the parsed URI, the server provides a link to the actual media file and records the request from the customer for record keeping or charging purposes, in the transaction database 815.

The link to the media file is preferably either (i) a relative reference to a secure location on the same server (i.e. the RSS transaction server 810), or (ii) a reference to a script on a remote server (which may be located at the merchant computer 820 or a different computer) that in turn references the secure location on that server to serve up the file to the user. The system is designed so that at no time is the actual URL of the file available to the customer.

Depending on the aggregator software used, customers may also choose to download additional enclosures from the feed or the aggregator software may automatically download more items from the feed, depending on how users have configured their RSS aggregator software 835. Regardless of whether it is customer or software activated, the action of requesting a file download is processed and recorded in the transaction database 815 as a purchase.

As noted previously, customers can log into their account to review the status of their current tab and previous purchases, or to update details. Merchants can use a web interface to create a merchant account and to add items to the system to be sold. A merchant can change the content associated with the RSS feed at the merchant's own website computer, or can change the metadata associated with the content by visiting the RSS transaction server.

According to certain embodiments, methods and systems are provided for delivering digital media content using a periodic feed (such as an RSS feed) and allowing recordation of the delivered media content as a transaction. The digital media content delivery method or system may associate a single user account with purchases and file downloads from within a standard RSS subscription and standard software clients across a range of merchant providers. The method or system may create a customized uniform resource identifier (URI) with the customer identification, item identification, price, affiliate and other information encoded into the URI. The URI can be used in place of a media URL within the RSS feed. The file URI is disguised so that the RSS aggregator software 835 believes it to be a valid URL to a media file that it can download. The request is intercepted at the RSS transaction server 810 and processed to record the transaction and serve up the appropriate file to the customer. The system preferably does not reveal the actual media location, or URL, at any time. A unique feature of the foregoing is that the processing happens by intercepting the media file request and processing the request for a media file, as opposed to relying primarily on, e.g., pre-processing scripts. This way, the file request alone is generally sufficient to generate all tracking of requests to users from the URI provided, and to serve up the appropriate media file.

In certain embodiments, purchases may be aggregated on a revolving “credit” account, in the form of a tab” where the aggregation is kept only until profitable to process to a form of payment. The tab may be automatically renewed to allow future subscription purchases to be processed.

In accordance with another embodiment, method for intercepting a custom URL that encodes customer, item, price and other relevant information at the server to translate the file request into a transaction record and serve up the appropriate file for the request and customer. The use of Custom URIs for downloadable items abstracts the file transaction request from the delivery of the actual media item to the requesting software. When the server receives a request for the custom URI, it parses it in accordance with pre-defined rules and serves the appropriate file to the requester and records the transaction. This action may be used to charge for small items of digital content purchased on a public network. Items downloaded are preferably recorded to a simplified method of aggregating small value payments on an auto-closing, revolving account (e.g., tab). Customers provide their payment details once, and can charge to their tab account transactions from multiple merchants via RSS delivery up to preset limits. Tab accounts are acquitted and reopened automatically when they reach the preset limit, or else at routine intervals or periodically.

The system and architecture described herein may have many different applications and uses. For example, it may be used to provide a commercial or security transaction. It may also be used to serve alternate files for different customers, or to limit access to certain files to affiliation groups or subsets of customers or clients. Those skilled in the art will perceive other additional uses or applications as well.

While preferred embodiments of the invention have been described herein, many variations are possible which remain within the concept and scope of the invention. Such variations would become clear to one of ordinary skill in the art after inspection of the specification and the drawings. The invention, therefore, is not to be restricted except within the spirit and scope of any appended claims.

What is claimed is:

1. A method, comprising:
intercepting, at a transaction server, a custom uniform resource identifier (URI) transmitted from a remote client computer, the custom URI referencing a requested digital media file;
interpreting the custom URI at the transaction server;
conveying a request to serve the requested digital media file to a remote content storage computer; and
recording the digital media file request in a customer transaction database.

2. The method of claim 1, wherein the remote content storage computer is affiliated with a merchant.

3. The method of claim 2, further comprising the step of recording a credit in favor of the merchant for the digital media file requested by the client computer.

4. The method of claim 1, wherein the transaction server has an account associated with the requesting client, and wherein a charge is applied to the client's account when the digital media file request is processed.

5. The method of claim 4, wherein the client account is periodically reviewed through an automated process and, when exceeding a predetermined amount, is cleared through an electronic financial credit or debit transaction carried out with a remote financial institution.

6. A method for automatically charging for files provided through an RSS feed, comprising:
receiving, at an RSS transaction server, a request for a digital media file sent from a remote client computer, said digital media file being stored at a remote merchant affiliated computer;
receiving, at the RSS transaction server, a verification of customer identity, the customer having a customer account with the RSS transaction server;
in response to the request, generating a custom RSS feed containing an identifier of the requested digital media file disguised as a media enclosure compatible with RSS aggregator software at the remote client computer;
transmitting the custom RSS feed from the RSS transaction server to the remote client computer;
receiving from the client computer a download request relating to the custom RSS feed;
in response to the download request from the client computer, securely serving the requested digital media file to the client computer, and recording a charge against a customer account relating to the requesting customer.
